(19) United States
(12) Patent Application Publication
(10) Pub. No.: US 2007/0136602 A1
(43) Pub. Date: Jun. 14, 2007

(54) User authentication system and method for supporting terminal mobility between user lines

(75) Inventors: No Ik Park, Seoul (KR); Soon Seok Lee, Daejeon-city (KR); Young Sun Kim, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/635,647

(22) Filed: Dec. 8, 2006

(30) Foreign Application Priority Data
Dec. 8, 2005 (KR) 10-2005-0119576
Jun. 1, 2006 (KR) 10-2006-0049269

(51) Int. Cl. H04L 9/32; G06K 9/00; G06F 12/14; H04L 9/00; G06F 17/30; G06F 12/00; H04K 1/00; G06F 15/16; G06F 13/00; G06F 7/04; G06F 7/58; G06K 19/00; G11C 7/00

(52) U.S. Cl. 713/182; 713/183; 726/5; 726/6; 726/7; 726/18; 726/19

(57) ABSTRACT

Provided is a user authentication system and method for supporting terminal mobility between user lines. The user authentication system includes: a binding checker that checks whether a user terminal ID and a circuit ID of a line currently connected to the user terminal are bound; a terminal/circuit information checker that checks whether the user terminal ID and the circuit ID are validly registered for a network service if the check result obtained by the binding checker shows that binding is not made; and a terminal authenticator that authenticates the user terminal by temporarily binding the user terminal ID and the circuit ID if the terminal/circuit information checker confirms validity of the registration. Accordingly, a pre-authenticated user terminal can receive a network service by accessing another user line. Therefore, it is possible to create various business models in which a service and a service fee system are determined according to an end user's SLA.

### CROSS-REFERENCE TO RELATED PATENT APPLICATION

This application claims the benefits of Korean Patent Application No. 10-2005-0119576, filed on Dec. 8, 2005, and Korean Patent Application No. 10-2006-0049269, filed on Jun. 1, 2006, in the Korean Intellectual Property Office, the disclosures of which are incorporated herein in their entirety by reference.

### BACKGROUND OF THE INVENTION

1. Field of the Invention

The present invention relates to a user authentication system and method for supporting terminal mobility between user lines, and more particularly, to a user authentication system and method in which a network user can receive a network service by using the user's own pre-authenticated terminal, irrespective of an access position.

2. Description of the Related Art

In general, the Internet conventionally employs a method in which only a single user ID is authenticated for a single user line. In this method, for user management, a user line ID managed by a communication provider is bound to a media access control (MAC) address of a user terminal. When the user terminal is authenticated, authentication is integrally carried out along with the user line ID. Network access is restricted if another terminal is used instead of that registered along with the user line ID when the service was started.

With such a configuration, mobility of a wire terminal is not allowed, and thus a network cannot be accessed if a terminal pre-authenticated along with a user line ID is connected to another user line.

In this configuration, a first user can receive a service based on a second user's service level agreement (SLA) instead of the first user's own SLA when the network is accessed using the second user's terminal. In this case, a service fee cannot be determined according to the first user's own SLA.

Meanwhile, portable terminals such as notebook computers are becoming widely used instead of desktop computers, and thus more and more portable terminals are demanded. In this environment, however, there is no system for enabling mobility of terminals between user lines.

### SUMMARY OF THE INVENTION

The present invention provides a user authentication method that can support terminal mobility by checking the binding state between a user terminal ID and a circuit ID of a line currently connected to the user terminal, and by checking the validity of a network service for the user terminal ID and the circuit ID.

According to an aspect of the present invention, the validity of a circuit ID for identifying a user line and the validity of a user terminal ID are respectively checked, so that network authentication can be carried out for a terminal of a guest user who attempts to access to a network by using his or her own terminal through a line dedicated to another user.

According to another aspect of the present invention, there is provided a user authentication system supporting terminal mobility, comprising: a binding checker that checks whether a user terminal ID and a circuit ID of a line currently connected to the user terminal are bound; a terminal/circuit information checker that checks whether the user terminal ID and the circuit ID are validly registered for a network service if the check result obtained by the binding checker shows that binding is not made; and a terminal authenticator that authenticates the user terminal by temporarily binding the user terminal ID and the circuit ID if the terminal/circuit information checker confirms validity of the registration.

In this case, the user terminal ID may be a MAC address of the user terminal. Preferably, the user terminal ID is a unique ID that distinguishes the user terminal from another user terminal.

The user authentication system may further comprise a user information storage that performs a storing operation by temporarily binding the pre-stored user terminal ID and the pre-stored circuit ID of a network service user.

In addition, the user authentication system may further comprise a user authenticator that determines success or failure of authentication by retrieving whether the network service user coincides with pre-registered user identification information when the user identification information is received from the user terminal after authentication is complete in the terminal authenticator.

In this case, the user identification information may be a user ID, a password, or biometric identification information, and is preferably unique information capable of identifying users.

According to another aspect of the present invention, there is provided a user authentication method supporting terminal mobility, comprising: checking whether a user terminal ID and a circuit ID of a line currently connected to the user terminal are bound; checking whether the user terminal ID and the circuit ID are validly registered for a network service if the check result obtained by the binding checker shows that binding is not made; and authenticating the user terminal by temporarily binding the user terminal ID and the circuit ID if the use terminal ID and the circuit ID are validly requested.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of a method of receiving a network service through a line connected to a user terminal according to an embodiment of the present invention;

FIG. 2 is a schematic diagram of a network service according to an embodiment of the present invention;

FIG. 3 is a block diagram illustrating an example of the user authentication system of FIG. 2;

FIG. 4 is a block diagram illustrating another example of the user authentication system of FIG. 2; and

FIG. 5 is a table illustrating an example of a user information list stored in the user information storage of FIG. 4.

### DETAILED DESCRIPTION OF THE INVENTION

Exemplary embodiments of the present invention will now be described in detail with reference to the accompanying drawings.

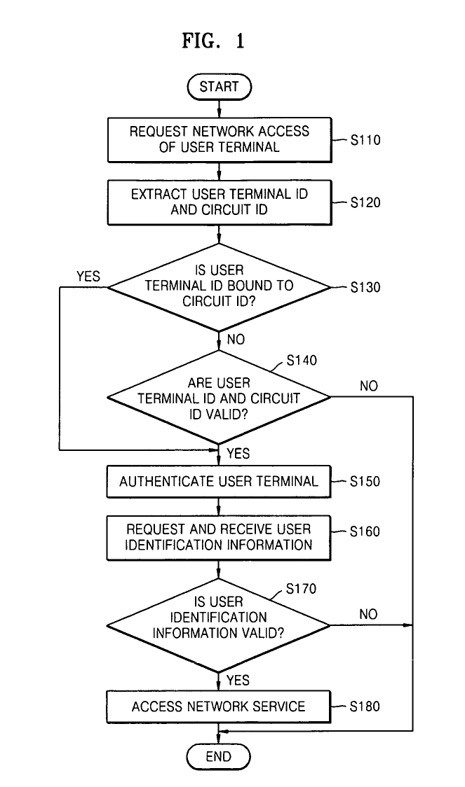

FIG. 1 is a flowchart of a method of receiving a network service through a line connected to a user terminal according to an embodiment of the present invention. Referring to FIG. 1, when network access is requested through a user terminal (operation S110), a user terminal ID and a circuit ID of a line currently connected to the user terminal are extracted (operation S120). Thereafter, the binding state of the extracted user terminal ID with respect to the circuit ID is checked (operation S130).

If the check result shows that binding is not made, the validity of a network service for the user terminal ID and the circuit ID is checked (operation S140).

If the check result in operation 130 shows that binding is made, or if the check result in operation S140 confirms validity, the user terminal ID and the circuit ID are temporarily bound, and the user terminal is authenticated (operation S150).

After authentication is done for the user terminal, user identification information is received (operation S160), and the validity of the user identification information is checked (operation S170). If valid, the network service is accessed (operation S180).

If the check result in operation S140 confirms invalidity, or the check result in operation S170 confirms invalidity, the network service is disconnected (operation S190).

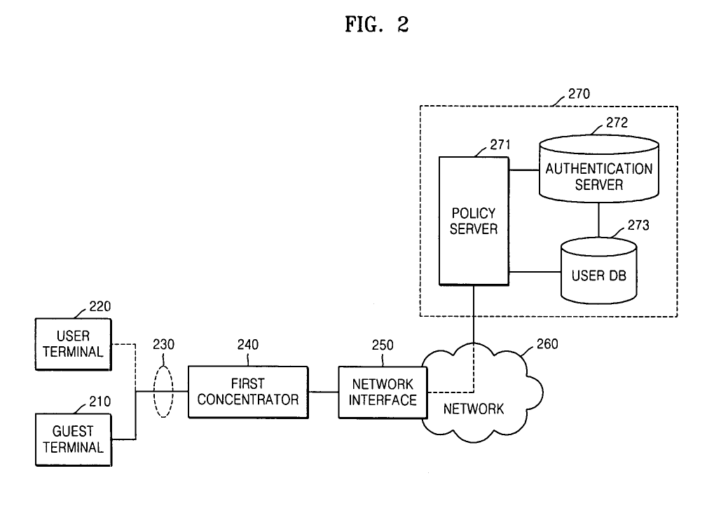

FIG. 2 is a schematic diagram of a network service according to an embodiment of the present invention. Referring to FIG. 2, the network service includes terminals 210 and 220, a circuit ID 230, an aggregator 240, an interface 250, and a user authentication system 270.

The circuit ID 230 is a unique identifier for a subscriber line that connects the terminals 210 and 220, such as digital subscriber line (DSL) modems or cable modems, to the first aggregator 240 of network, that is, a digital subscriber line access multiplexer (DSLAM) or a cable modem termination system (CMTS).

The network interface 250 performs a dynamic host configuration protocol (DHCP) relay function in the terminal, and re-directs user packets which are generated in the process of authentication to a policy server 271.

The network 260 is an internet protocol (IP) network through which services can be provided according to individual users' service level agreements (SLAs).

The user authentication system 270 may include various sub-systems. Examples of the sub-systems according to an embodiment of the present invention include the policy server 271, which generally enacts a service-related policy, an authentication server 272, which retrieves user identification information to determine success or failure of authentication, and a user DB 273, which records general information related to a user.

The user DB 273 is a medium that can bind and store the circuit ID, the user identification information, and an IP address of a service user.

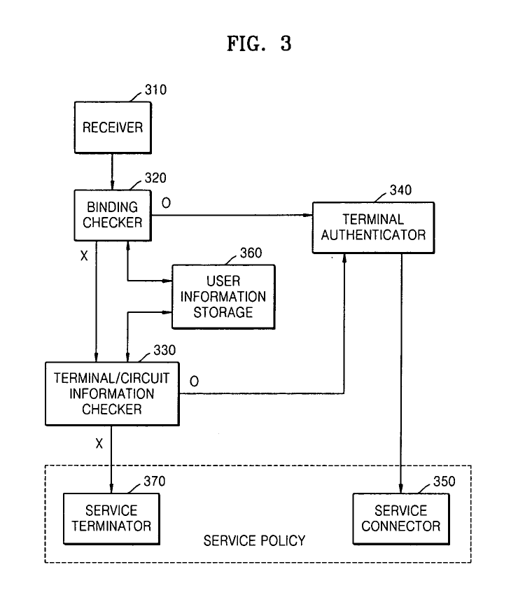

FIG. 3 is a block diagram illustrating an example of the user authentication system 270 of FIG. 2. Referring to FIG. 3, the user authentication system 270 includes a receiver 310, a binding checker 320, a terminal/circuit information checker 330, a terminal authenticator 340, a service connector 350, a user information storage 360, and a service terminator 370.

First, the receiver 310 receives a request for using a user terminal. Then, a user terminal ID and a circuit ID of a line currently connected to the user terminal are extracted.

The binding checker 320 then checks the binding state of the user terminal ID and the circuit ID extracted from the receiver 310.

If the check result obtained from the binding checker 320 shows that binding is not made, the terminal/circuit information checker 330 checks the validity of a network service for the user terminal ID and the circuit ID.

If the check result obtained from the terminal/circuit information checker 330 confirms invalidity, the service terminator 290 terminates service. Otherwise, the terminal authenticator 340 temporarily bonds the user terminal ID and the circuit ID for authentication.

After authentication is complete, the service connector 350 provides a network service.

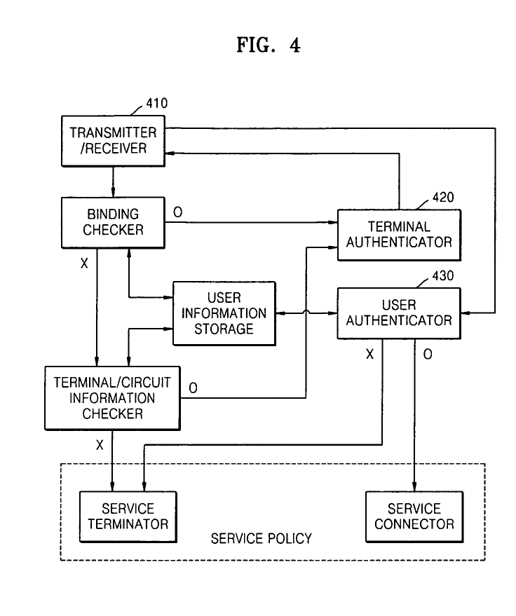

FIG. 4 is a block diagram illustrating another example of the user authentication system 270 of FIG. 2. The configuration of FIG. 4 is the same as that of FIG. 3, except for a transmitter/receiver 410, a terminal authenticator 420, and a user authenticator 430.

First, in addition to the function of the receiver 210, the transmitter/receiver 410 requests and receives user identification information of the user terminal.

After authentication of the user terminal ID and the circuit ID is complete, the terminal authenticator 420 allows the transmitter/receiver 410 to request the user identification information of the user terminal.

The user authenticator 430 then determines whether the user identification information is valid. If valid, the service connector 350 provides a network service. Otherwise, the service terminator 290 terminates the network service.

In this process, the binding checker 320, the terminal/circuit information checker 330, and the user authenticator 430 retrieve information stored in the user information storage 360.

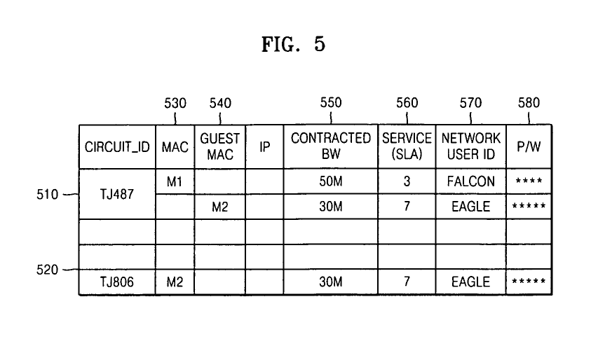

FIG. 5 is a table illustrating an example of a user information list stored in the user information storage 360 of FIG. 4. Referring to FIG. 5, the user information list may include a circuit ID, a MAC address, an IP, a BM, a user ID, and a P/W.

First, when a user 520 whose user ID is eagle and user circuit ID is TJ860 desires network access using that user's own terminal, through the line of another user 510 whose user ID is falcon and user circuit ID is TJ487, the user 520 whose user ID is eagle becomes a guest user.

When the guest user is authenticated, an address M2 which is a terminal address of eagle is registered in a guest MAC 540, in addition to a terminal address of falcon which is registered in a MAC 530 and authenticated for the circuit of TJ487.

Next, a contracted bandwidth 550, a SLA 560, a user ID 570, and a P/W 580 of eagle are recorded, and network usage is managed for eagle.

Accordingly, the decision of whether to provide a network service is made by separately checking the validities of a user terminal ID and a circuit ID, thereby allowing mobility of a user terminal between user lines. Thus, a user can access a network irrespective of an access position of a user line, by using the user's own pre-authenticated terminal, and can receive a network service based on the user's own SLA. In addition, it is possible to create a new business model in which a service fee is determined according to an end user's SLA.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and detail may be made therein without departing from the spirit and scope of the present invention as defined by the appended claims.

What is claimed is:

1. A user authentication system supporting terminal mobility, comprising:
a binding checker that checks whether a user terminal ID and a circuit ID of a line currently connected to the user terminal are bound;
a terminal/circuit information checker that checks whether the user terminal ID and the circuit ID are validly registered for a network service if the check result obtained by the binding checker shows that binding is not made; and
a terminal authenticator that authenticates the user terminal by temporarily binding the user terminal ID and the circuit ID if the terminal/circuit information checker confirms validity of the registration.

2. The user authentication system of claim 1, further comprising a service interface that connects the user terminal to the network service when authentication is complete in the terminal authenticator.

3. The user authentication system of claim 1, wherein the user terminal ID is a MAC address of the user terminal.

4. The user authentication system of claim 1, further comprising a user information storage that performs a storing operation by temporarily binding the pre-stored user terminal ID and the pre-stored circuit ID of a network service user

5. The user authentication system of claim 4, wherein the terminal/circuit information checker checks whether the user terminal ID and the circuit ID are validly registered by retrieving the user information storage.

6. The user authentication system of claim 1, further comprising a user authenticator that determines success or failure of authentication by retrieving whether the network service user coincides with pre-registered user identification information, when the user identification information is received from the user terminal after authentication is complete in the terminal authenticator.

7. A user authentication method supporting terminal mobility, comprising:
checking whether a user terminal ID and a circuit ID of a line currently connected to the user terminal are bound;
checking whether the user terminal ID and the circuit ID are validly registered for a network service, if the check result obtained by the binding checker shows that binding is not made, if the check result obtained by the binding checker shows that binding is made authenticating the user terminal directly
authenticating the user terminal by temporarily binding the user terminal ID and the circuit ID if the use terminal ID and the circuit ID are validly requested.

8. The user authentication method of claim 7, further comprising connecting the user terminal to the network service when authentication is complete in the authenticating the user terminal.

9. The user authentication method of claim 7, wherein the user terminal ID is a MAC address of the user terminal.

10. The user authentication method of claim 7, further comprising determining success or failure of authentication by retrieving whether the network service user coincides with pre-registered user identification information, when the user identification information is received from the user terminal after authentication is complete in the authenticating the user terminal.

11. A computer-readable medium having embodied thereon a computer program for executing the method of any one of claims 7.
